(19) United States
(12) Patent Application Publication
(10) Pub. No.: US 2012/0059932 A1
(43) Pub. Date: Mar. 8, 2012

(54) APPLYING HOME NETWORK TECHNOLOGIES TO A WIDE AREA NETWORK

(75) Inventors: Alan MESSER, Los Gatos, CA (US); Jay ENDSLEY, San Jose, CA (US)

(73) Assignee: SAMSUNG ELECTRONICS CO., LTD., Suwon City (KR)

(21) Appl. No.: 13/162,456

(22) Filed: Jun. 16, 2011

Related U.S. Application Data
(60) Provisional application No. 61/379,677, filed on Sep. 2, 2010.

(51) Int. Cl. G06F 15/173

(52) U.S. Cl. 709/224

(57) ABSTRACT

In a first embodiment of the present invention, a method for allowing a device on a home network to access a service outside the home network is provided, the method comprising: receiving, at a server outside the home network, a registration message from the service; storing details about the service in a storage accessible by the server, wherein the details include an address for the service; receiving, at the server, a request to locate a service, wherein the request is received from the home network; locating details about a matching service stored in the storage, wherein the matching service meets criteria specified in the request from the home network; and providing the details about the matching service to the home network, enabling the device to directly contact the matching service using the address specified in the details about the matching service.

This application claims the benefit of priority under 35 U.S.C. 119(e) to U.S. Provisional Patent Application No. 61/379,677, filed Sep. 2, 2010, which is incorporated herein by reference for all purposes.

### BACKGROUND OF THE INVENTION

1. Field of the Invention

The present invention relates generally to home networking. More specifically, the present invention relates to the application of home network technologies to a wide area network.

2. Description of the Related Art

Home networking has advanced from the early days of merely linking computers and printers to the modern home network, which can include mobile devices, televisions, set-top boxes, refrigerators, etc.

Universal Plug and Play (UPnP) is a distributed, open networking architecture that allows devices to connect seamlessly and to simplify the implementation of networks in the home (data sharing, communications, and entertainment) and corporate environments. UPnP achieves this by defining and publishing UPnP device control protocols built upon open, Internet-based communication standards.

UPnP has grown in popularity of late in part due to the rise in popularity of media servers. Media servers are small computers that store multiple types of content (e.g., photos, music, videos, etc.). The content may then be streamed from a media server to one or more control points (e.g., iPod, television set, etc.).

UPnP principally applies to local area networks (LANs), specifically home area networks. UPnP allows devices on the LAN to discover other devices, read their description, give commands, and send events. UPnP is currently only applied to LAN environments because UPnP discovery is performed using Internet Protocol (IP) multicasting. This discovery mechanism, while suitable for home use, is not scalable to public networking systems.

Discovery servers on a local network that listen to discovery traffic have been proposed as a way to scale discovery to larger networks. In this solution, the directory servers intercept and collect the local multicast traffic and then unicast the information about devices on the home network to centralized servers that are administered to select which devices are visible where. Doing so causes the discovery packets to be limited to the LAN networks and only unicast packets flow on the Wide Area Network (WAN) or other LANs, thereby controlling traffic. This solution, however, requires the presence of such directory servers, and is thus not typically transparent to the user of the home network.

As such, a solution is needed that operates differently than prior art solutions.

### SUMMARY OF THE INVENTION

In a first embodiment of the present invention, a method for allowing a device on a home network to access a service outside the home network is provided, the method comprising: receiving, at a server outside the home network, a registration message from the service; storing details about the service in a storage accessible by the server, wherein the details include an address for the service; receiving, at the server, a request to locate a service, wherein the request is received from the home network; locating details about a matching service stored in the storage, wherein the matching service meets criteria specified in the request from the home network; and providing the details about the matching service to the home network, enabling the device to directly contact the matching service using the address specified in the details about the matching service.

In a second embodiment of the present invention, a method for accessing a service outside a home network from a device within the home network is provided, the method comprising: sending a unicast request, from the device to a well-known cloud service, to find a service; receiving, from the well-known cloud service, an identification of a service and an address for the service, wherein the well-known cloud service sends the identification of the service and the address for the service based upon information stored from registrations of various services with the well-known cloud service; and contacting the address for the service to access the service.

In a third embodiment of the present invention, a cloud service is provided comprising: an interface to a home network; an interface to Internet services; a storage; a processor configured to: receive a registration message from one of the Internet services via the interface to Internet services; store details about the one of the Internet services in the storage, wherein the details include an address for the service; receive a request to locate a service, wherein the request is received from the home network via the interface to the home network; locate details about a matching service stored in the storage, wherein the matching service meets criteria specified in the request from the home network; and provide the details about the matching service to the home network via the interface to the home network, enabling a device in the home network to directly contact the matching service using the address specified in the details about the matching service.

In a fourth embodiment of the present invention, a system is provided comprising: a home network including a device; a well-known cloud service located outside the home network; and a service located outside the home network; wherein the service is configured to register details about itself with the well-known cloud service via a UPnP advertisement message having extra headers describing the details about the service; wherein the service is configured to: store the details about the service in a storage; receive a request to locate a service from the home network; locate details about a matching service stored in the storage; and send the details about the matching service to the home network.

In a fifth embodiment of the present invention, an apparatus for allowing a device on a home network to access a service outside the home network is provided, the apparatus comprising: means for receiving, at a server outside the home network, a registration message from the service; means for storing details about the service in a storage accessible by the server, wherein the details include an address for the service; means for receiving, at the server, a request to locate a service, wherein the request is received from the home network; means for locating details about a matching service stored in the storage, wherein the matching service meets criteria specified in the request from the home network; and means for providing the details about the matching service to the home network, enabling the device to directly contact the matching service using the address specified in the details about the matching service.

In a sixth embodiment of the present invention, a non-transitory program storage device readable by a machine tangibly embodying a program of instructions executable by the machine to perform a method for allowing a device on a home network to access a service outside the home network is provided, the method comprising: receiving, at a server outside the home network, a registration message from the service; storing details about the service in a storage accessible by the server, wherein the details include an address for the service; receiving, at the server, a request to locate a service, wherein the request is received from the home network; locating details about a matching service stored in the storage, wherein the matching service meets criteria specified in the request from the home network; and providing the details about the matching service to the home network, enabling the device to directly contact the matching service using the address specified in the details about the matching service.

### BRIEF DESCRIPTION OF THE DRAWINGS

FIG. 1 is a system diagram illustrating one example embodiment of the present invention.

FIG. 2 is a diagram illustrating an example embodiment of the present invention where a webcam is used.

FIG. 3 is a diagram illustrating another example embodiment of the present invention where a gateway is used.

FIG. 4 is a diagram illustrating another example embodiment of the present invention where gateways are installed in two distinct home networks.

FIG. 5 is a diagram illustrating another example embodiment of the present invention where home servers are used.

FIG. 6 is a diagram illustrating another example embodiment of the present invention where energy management is performed.

FIG. 7 is a diagram illustrating another example embodiment of the present invention where a remote user interface is utilized.

FIG. 8 is a diagram illustrating another example embodiment of the present invention where a remote user interface is provided to a web service.

FIG. 9 is a flow diagram illustrating a method for allowing a device on a home network to access a service outside the home network in accordance with an embodiment of the present invention.

FIG. 10 is a flow diagram illustrating a method for accessing a service outside a home network from a device within the home network in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

It should be noted that the term “home networking” as used throughout this document refers to a type of network that is commonly used in homes to connect media devices. There is no requirement, however, that this type of networking actually be used in homes, as it has equal applicability for use in businesses or other entities. As such, the term “home networking” shall not be construed as limiting any embodiments of the present invention to use in a home, and shall be interpreted as any type of local area network (LAN).

It should also be noted that the term “unicast” as used throughout this document refers to any communication sent to a single destination.

The present invention involves a solution that allows UPnP to be used in WAN environments by approaching the problem from a different perspective and with a different goal than prior art solutions. Rather than limiting the traffic in the LAN environment, an embodiment of the present invention changes the UPnP protocol to remove the need for LAN discovery traffic altogether. Of course, a device may still perform LAN-side discovery should it so desire, but it is no longer required, allowing WAN discovery to be achieved in a much improved manner. In an embodiment of the present invention, the device can also be connected to a cloud service to perform a scalable query on a centralized directory. This directory can contain the addresses of the description documents from Internet servers running a UPnP service. Those UPnP Internet servers are similarly modified to run UPnP services but do not send out discovery advertisements because they are configured to only serve WAN clients.

With this structure in place, UPnP devices are able to use the same protocols to perform services with WAN-based servers by only making small changes to the discovery advertisement and search processes in the existing UPnP architecture.

In an embodiment of the present invention, devices or machines wanting to advertise a UPnP service do so by sending a UPnP advertisement message (such as a NOTIFY message) to a well-known cloud service on the Internet. This request may have headers added to it to describe the device type, manufacturer, location (e.g., via Global Position Service, service provider, or other information that allows the system to determine the type(s) of device it wishes to service). In that sense, the information may be information pertaining to the type of device the service wishes to service, or may be information pertaining to the service itself. The cloud service may be located on an Internet server. The Internet server then keeps this information and then awaits updated NOTIFY messages from the service periodically (e.g., daily) to allow it to keep a fresh state of servers and services.

UPnP devices then can contact the well-known cloud service via the Internet to locate services it can subscribe to. The UPnP device may send a service request to the cloud service including headers added to it to describe the device type, manufacturer, location, service provider, or other information to determine the type of device or service it wishes to search for. The server then can search its database of registered services and return the result to the device. Once discovery is complete, the client can interact with the service just as it would had it discovered it locally.

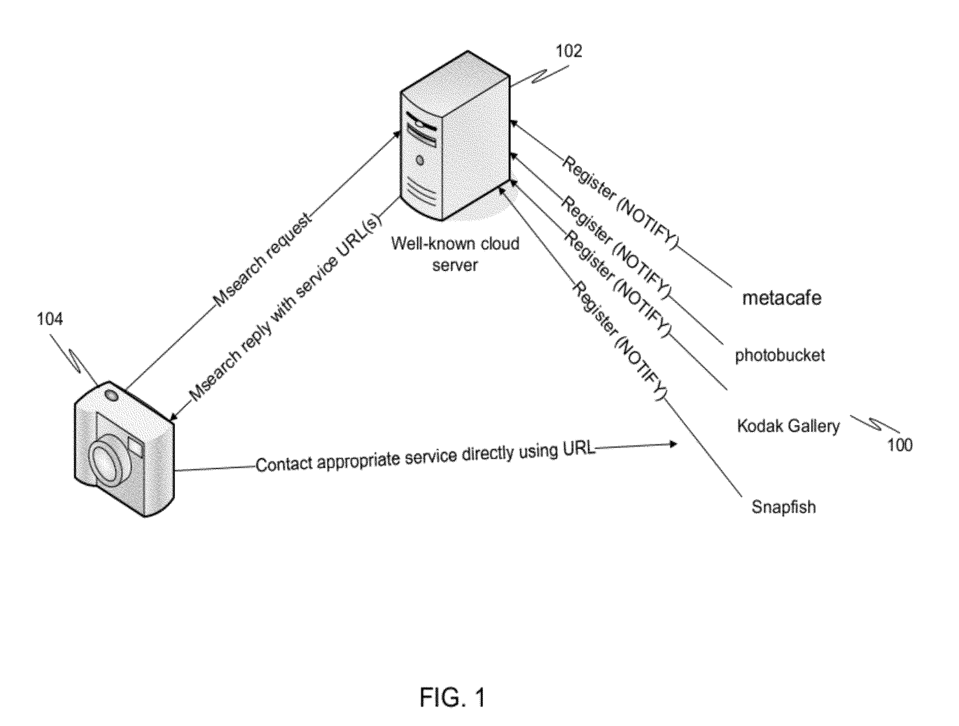

FIG. 1 is a system diagram illustrating one example embodiment of the present invention. Devices or machines running services 100 wanting to advertise a UPnP service send out a unicast UPnP advertisement message (NOTIFY) with extra headers to a well-known cloud service 102. As described above, this request may have additional headers added to it to describe the device type, manufacturer, location, service provider, or other information to determine the type(s) of device(s) it wishes to service. The well-known cloud service 102 stores the information from the advertisement messages and awaits updated advertisement messages periodically to allow it to keep a fresh state of servers and services.

When a user wishes to use a UPnP service, the user's device 104 contacts the well-known cloud service 102 using a service request. This request can use an existing Simple Service Discovery Protocol (SSDP) MSearch request, but sends it unicast to the well-known cloud service and additional headers are added to it to describe the device type, manufacturer, location, service provider, etc. The well-known cloud service 102 searches its database of registered services (from the advertisement messages), perhaps filtered using the information regarding the types of devices the services wish to service and the actual type of device from which the service request was sent, and then returns a set of possible services. This set may be returned in an MSearch unicast reply, using the existing UPnP format, so it looks to the client as if it came from a local service in response to a traditional multicast service request. In reality, it was received over a unicast connection in reply to the specialized MSearch request to the well-known cloud service 102.

The client device 104 then uses this reply as it would normally. It contains a URL in order to fetch the device description of the device running the service, so it can either fetch this or begin communication with the services associated with that device through an API.

In some embodiments of the present invention, client devices may subscribe to events on the server. However, this only makes sense for certain services. For example, an Internet server acting as a content directory service may not allow clients to subscribe to content change requests. This is the same as a local device that chooses not to reply to those subscription requests.

In some other embodiments of the present invention, client devices may themselves register with the well-known cloud service, allowing services to issue general requests for devices and having the well-known cloud service return a list of potentially matching devices.

With all embodiments, there may be security concerns that can be alleviated using various authentication or other security techniques. In one example embodiment, the well-known cloud service simply keeps all device information private, not sharing it with services. In such an embodiment, it is even possible that the server never be made aware of the matching devices. The services will simply be contacted directly from whatever devices choose to do so. In another embodiment of the present invention, client authentication is performed prior to the device contacting the well-known cloud server. In such embodiments, the well-known cloud server may pass along authentication credentials for the device to the appropriate service(s), essentially pre-authenticating the user with the services. This may be helpful in reducing the number of steps that needs to be undertaken on the part of the device to establish the connection to the service.

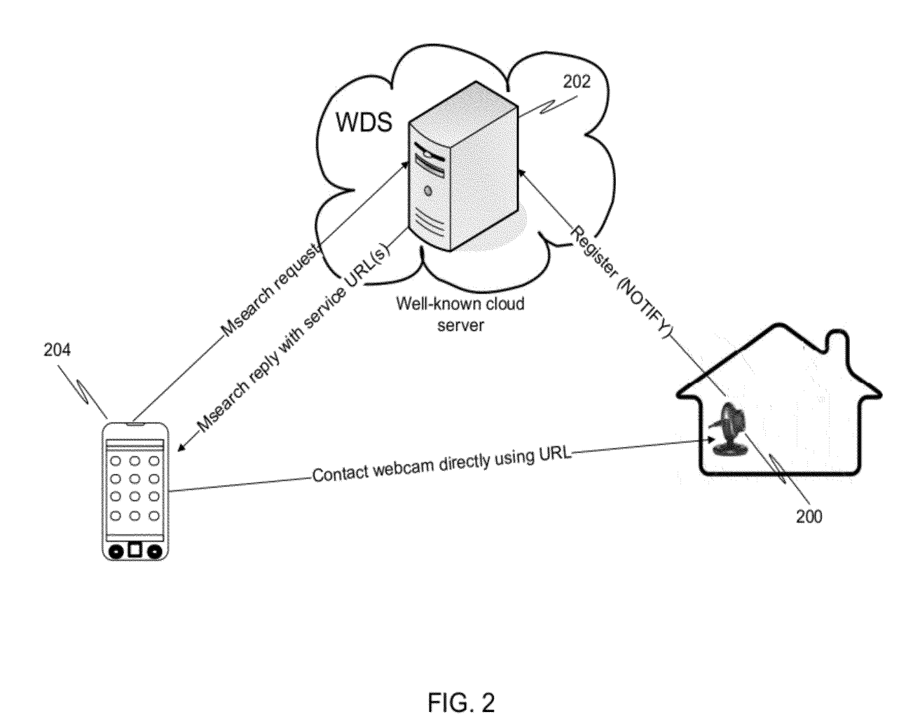

In one example embodiment of the present invention, a webcam is used as the UPnP service. FIG. 2 is a diagram illustrating this example. Here, a user installs a UPnP webcam 200 in a home network. The webcam is configured to enable WAN discovery service (WDS), which utilizes a well-known cloud service 202. The webcam 200 connects to and registers with the WDS server 202. Various webcam settings, such as geo-location, access code, etc. can be transmitted when registering. Then the WDS server 202 stores the information about the webcam in a storage. Now the webcam can be discovered by other devices using WDS.

A user can discover and access the UPnP webcam 200 from outside the home network with a device, such as mobile phone 204 having a software application that communicates with the UPnP Webcam 200 in the home. The mobile device 204 first communicates with the WDS server 202 to search for and obtain details about services available, including service addresses. Then the mobile device 204 can directly communicate with an appropriate service using the service's address. There may be various ways in which this communication occurs. In one example, the UPnP Remote access protocol is used to establish the connection between the WAN device and the LAN device.

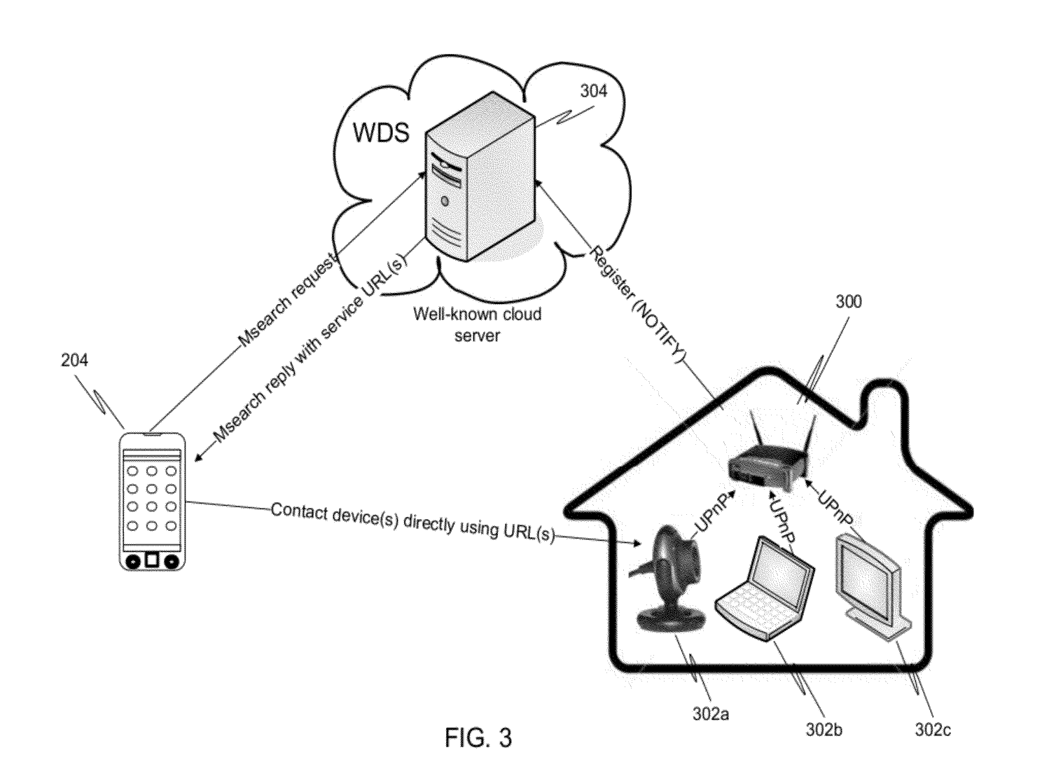

FIG. 3 is a diagram illustrating another example embodiment of the present invention where a gateway is used. The user installs a WDS gateway 300 in the home network. The WDS gateway 300 translates legacy UPnP protocols to WDS. UPnP devices 302a, 302b, 302c in the home are not required to understand WDS protocols, only currently defined UPnP protocols. The WDS gateway 300 monitors the home network and automatically registers the UPnP devices 302a, 302b, 302c with the WDS server 304.

A user can discover and access any of the UPnP devices 302a, 302b, 302c in the home network with a device, such as mobile phone 306 having a software application that communicates with the appropriate UPnP device 302a, 302b, 302c in the home. The mobile phone 306 first communicates with the WDS server 202 to search for and obtain details about devices available, including device addresses. Then the mobile phone 306 can directly communicate with an appropriate device using the device's address. There may be various ways in which this communication occurs. In one example, the UPnP Remote access protocol is used to establish the connection between the WAN device and the LAN device.

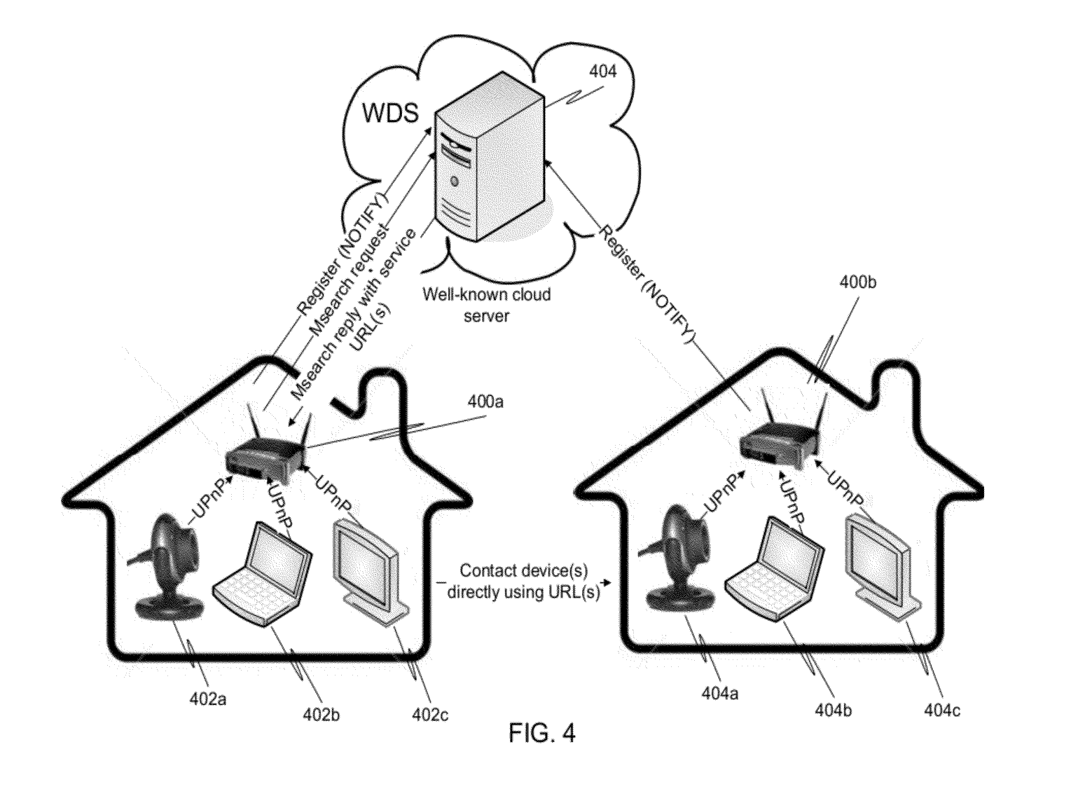

FIG. 4 is a diagram illustrating another example embodiment of the present invention where gateways are installed in two distinct home networks. Users in each home install WDS gateways 400a, 400b in their respective home networks. The WDS gateways 400a, 400b translate legacy UPnP protocols to WDS. UPnP devices in each home 402a, 402b, 402c and 404a, 404b, 404c, respectively are not required to understand WDS protocols. The WDS gateways 400a, 400b in each of the homes monitor the home network and automatically register the UPnP devices with the WDS server 404. Users in each home can then discover and access the UPnP device in the other home network through the WDS gateway device 400a, 400b, which connects to the WDS server 404 to retrieve whatever information is needed to communicate with the appropriate device in the other network. In one example, the UPnP Remote access protocol is used to establish the connection between the UPnP device in one home network and the UPnP device in the other.

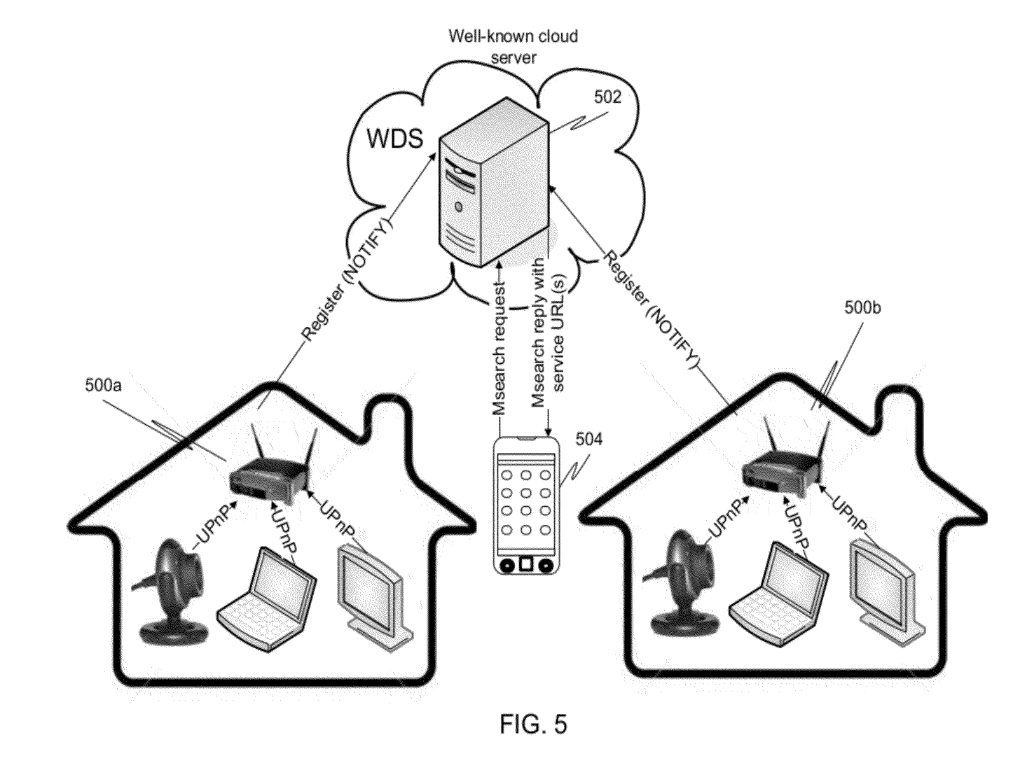

FIG. 5 is a diagram illustrating another example embodiment of the present invention where home servers are used. Like the embodiment of FIG. 4, users install WDS gateways 500a, 500b in their respective home networks. The WDS gateways 500a, 500b translate legacy UPnP protocols to WDS. These gateways 500a, 500b register various UPnP devices with the WDS server 502. The user can discover and access the UPnP device in either home network from the WAN using a device, such as mobile phone 504, with a software application that communicates with the WDS to establish a connection into the home. The mobile phone 504 first communicates with the WDS server 502 to search for and obtain details about devices available, including device addresses. Then the mobile device 204 can directly communicate with an appropriate device using the service's address. A device in one home network can also communicate with the WDS to establish a connection with a device in the other home network. In one example, the UPnP Remote access protocol is used to establish the connection between the devices in the WAN and those in the LAN, or between devices in one home network and devices in another.

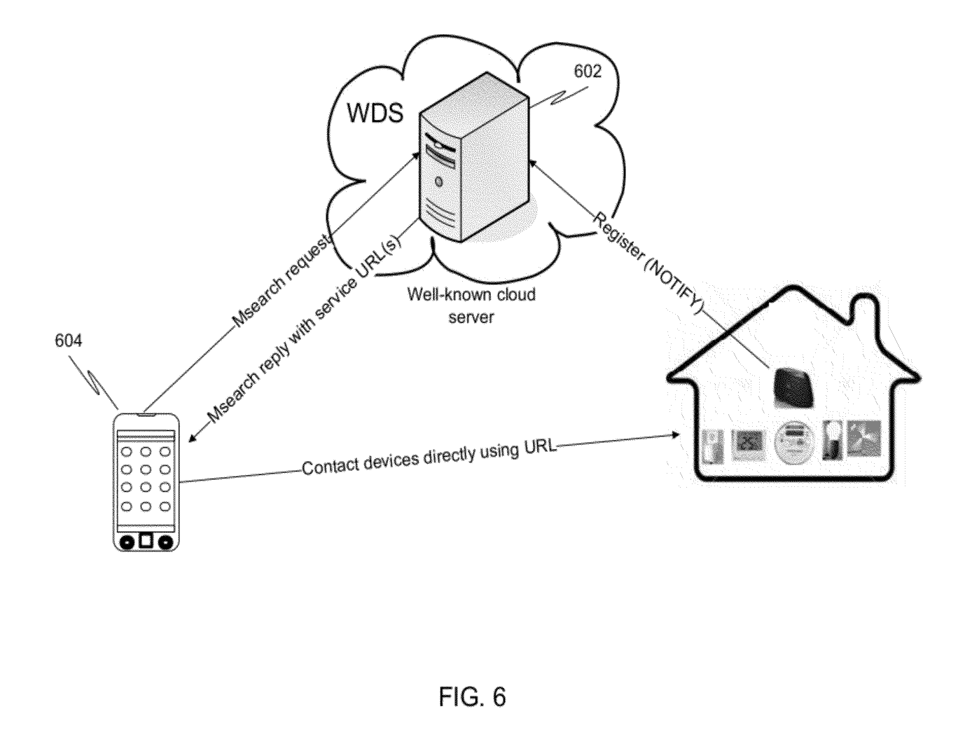

FIG. 6 is a diagram illustrating another example embodiment of the present invention where energy management is performed. A user installs a home energy management system or home control system 600 on the home network. The system 600 has a UPnP interface for master control. The system 600 is configured to enable WDS. The system 600 also has settings describing geo-location, access code, WDS to use, etc. The UPnP system controller connects and registers with the WDS server 602. Now all devices in the system can be discovered using the WDS. A user can discover and access the system in the home network with a device, such as mobile phone 604 having a software application that communicates with the system. There may be various ways in which this communication occurs. In one example, the UPnP Remote access protocol is used to establish the connection between the WAN device and the home energy management or home control system.

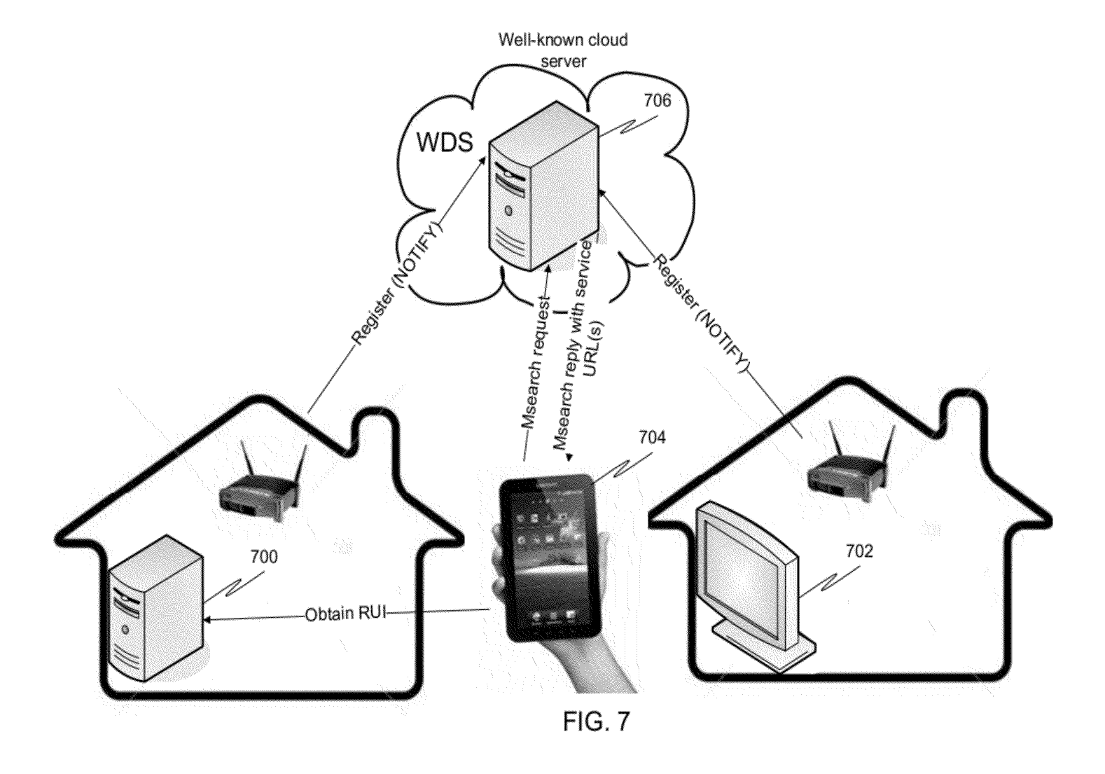

FIG. 7 is a diagram illustrating another example embodiment of the present invention where a remote user interface is utilized. Users install a UPnP server 700 in a first home network and a UPnP player 702 in a second home network. Both the server 700 and the player 702 are configured to enable WDS. Both the server 700 and the player 702 also have settings describing geo-location, access code, WDS to use, etc. The server 700 includes a DLNA remote user interface server, which is UPnP based. The user can then discover and access the server 700 in the home network from a WAN using a device, such as a tablet computer 704 with a software application that communicates with the WDS server 706. The remote user interface server 700 in home network can be accessed by the player 702 in the home network 710 or by the tablet computer 704. A user interface is projected from the server 700 in the home network to the player 702 or table computer 704.

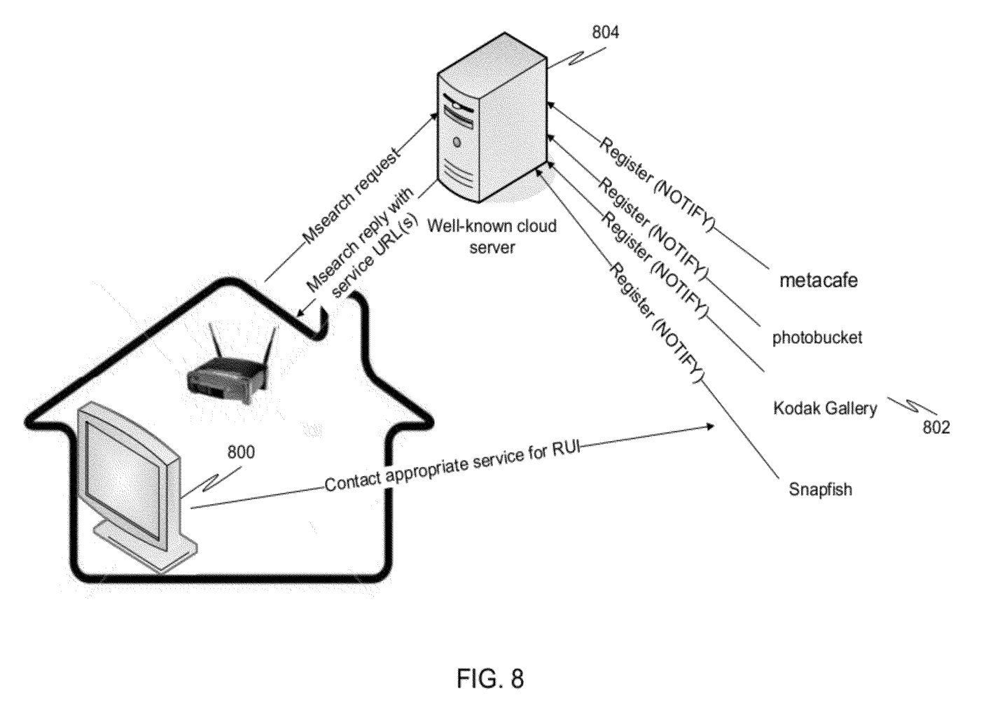

FIG. 8 is a diagram illustrating another example embodiment of the present invention where a remote user interface is provided to a web service. Users install a UPnP player device 800 with a DLNA remote user interface player. The player device is configured to enable WDS. The player device 800 also has settings describing geo-location, access code, WDS to use, etc. Internet services 802 register with the WDS server 804. Each service can include a DLNA remote user interface server, which is UPnP based. The player device 800 in the home network contacts the WDS server 804 to discover the Internet services 802. The Remote user interface player in the home network connects to the remote UI service provided by the appropriate Internet service 802. The RUI server provides a graphical UI on the RUI player in the home network that allows the user to interact and use the appropriate Internet Service 802.

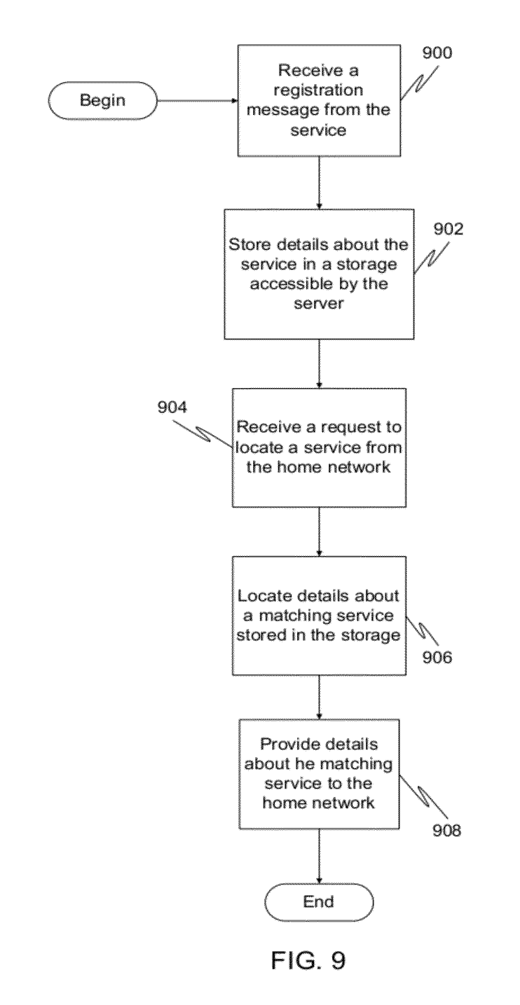

FIG. 9 is a flow diagram illustrating a method for allowing a device on a home network to access a service outside the home network in accordance with an embodiment of the present invention. This method may be performed at a server located outside the home network (in a well-known cloud service). At 900, a registration message is received from the service. The registration message may contain details about the service. The additional details may be contained in, for example, extra headers appended to a unicast UPnP advertisement message. At 902, these details (and potentially others as well) about the service are stored in a storage accessible by the server. The details may include, for example, an address (e.g., URL) for the service. At 904, a request to locate a service is received from the home network. This request may be, for example, an SSDP MSearch Unicast request. It may have additional details about the device stored in, for example, extra headers of the message. This request may be in a “format other than that utilized to communicate in the home network”. This phrase means that the typical home networking protocol used in the home network will either not be utilized (in favor of a different protocol), or a modification of the home networking protocol may be used (such as, for example, adding additional headers to a typical home networking protocol request, or sending the request via unicast when the typical home networking protocol request is multicast).

At 906, the server may locate details about a matching service stored in the storage. This matching may be accomplished by examining criteria specified in the request and comparing it to details found in the storage. For example, the details found in the storage may indicate a type of device that is compatible with a particular service and the criteria specified in the request could include details about the device, allowing the server to determine if a match is possible. It should be noted, however, that the request to locate a service may have criteria regarding the type of service to find, and the matching may include attempting to fulfill these types of criteria as well. For example, the request to locate a service may come from a digital camera and specify that it is looking for a service that operates on an image format utilized by the digital camera. The server is then able to locate a service or services that operate on that image format.

At 908, details about the matching service are provided to the home network, enabling the device to directly contact the matching service using the address specified in the details about the matching service. This may be accomplished by, for example, sending an msearch unicast reply. The advantage of an MSearch unicast reply is that it uses UPnP protocols, and therefore looks to the home network as if it came from a local device in response to a multicast msearch request even though it in reality came from outside the home network in response to a unicast msearch request.

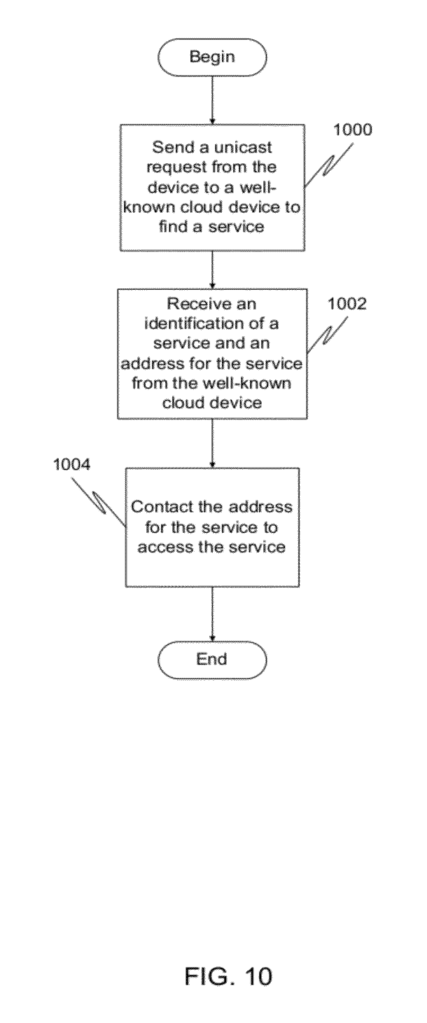

FIG. 10 is a flow diagram illustrating a method for accessing a service outside a home network from a device within the home network in accordance with an embodiment of the present invention. This method may be performed on a device in the home network. At 1000 a unicast request is sent from the device to a well-known cloud service to find a service. At 1002, an identification of a service and an address for the service are received from the well-known cloud service. This information is sent based upon information stored from registrations of various services with the well-known cloud service. At 1004, the address for the service is contacted to access the service. This may take the form of fetching a device description or alternatively may involve using a service API (defined by the vendor or otherwise).

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for allowing a device on a home network to access a service outside the home network, the method comprising:
receiving, at a server outside the home network, a registration message from the service;
storing details about the service in a storage accessible by the server, wherein the details include an address for the service;
receiving, at the server, a request to locate a service, wherein the request is received from the home network;
locating details about a matching service stored in the storage, wherein the matching service meets criteria specified in the request from the home network; and
providing the details about the matching service to the home network, enabling the device to directly contact the matching service using the address specified in the details about the matching service.

2. The method of claim 1, wherein the request received from the home network is a unicast request.

3. The method of claim 2, wherein the request received from the home network is an msearch request.

4. The method of claim 1, wherein the criteria specified in the request includes information about the device.

5. The method of claim 4, wherein the details about the service further include identifications of the types of devices compatible with the service and wherein the information about the device included in the criteria specified in the request includes an identification of the type of device.

6. The method of claim 1, wherein the server outside the home network is a well-known cloud server.

7. The method of claim 6, wherein the well-known cloud server is a Wide Area Network Discovery Service (WDS).

8. The method of claim 6, wherein the request received from the home network is directly received from the device in a format other than that utilized to communicate within the home network.

9. The method of claim 6, wherein the request received from the home network is received from a server within the home network in a format other than that utilized to communicate within the home network, wherein the server within the home network receives a request to locate a service from the device in a format utilized to communicate within the home network.

10. The method of claim 9, wherein the format utilized to communicate within the home network is a UPnP protocol.

11. The method of claim 1, wherein the service is located in another home network.

12. A method for accessing a service outside a home network from a device within the home network, the method comprising:
sending a unicast request, from the device to a well-known cloud service, to find a service;
receiving, from the well-known cloud service, an identification of a service and an address for the service, wherein the well-known cloud service sends the identification of the service and the address for the service based upon information stored from registrations of various services with the well-known cloud service; and
contacting the address for the service to access the service.

13. The method of claim 12, wherein the contacting includes fetching a device description.

14. The method of claim 12, wherein the contacting includes accessing the service using a service Application Program Interface (API).

15. The method of claim 12, wherein the identification of the service and the address for the service are received in the form of a notify message.

16. The method of claim 12, wherein the unicast request is an msearch request.

17. A cloud service comprising:
an interface to a home network;
an interface to Internet services;
a storage;
a processor configured to:
receive a registration message from one of the Internet services via the interface to Internet services;
store details about the one of the Internet services in the storage, wherein the details include an address for the service;
receive a request to locate a service, wherein the request is received from the home network via the interface to the home network;
locate details about a matching service stored in the storage, wherein the matching service meets criteria specified in the request from the home network; and
provide the details about the matching service to the home network via the interface to the home network, enabling a device in the home network to directly contact the matching service using the address specified in the details about the matching service.

18. The cloud service of claim 17, wherein the interface to the home network and the interface to the Internet services both utilize WDS.

19. A system comprising:
a home network including a device;
a well-known cloud service located outside the home network; and
a service located outside the home network;
wherein the service is configured to register details about itself with the well-known cloud service via a UPnP advertisement message having extra headers describing the details about the service;
wherein the service is configured to:
store the details about the service in a storage;
receive a request to locate a service from the home network;
locate details about a matching service stored in the storage; and
send the details about the matching service to the home network.

20. The system of claim 19, wherein the service is located in another home network.

21. An apparatus for allowing a device on a home network to access a service outside the home network, the apparatus comprising:
means for receiving, at a server outside the home network, a registration message from the service;
means for storing details about the service in a storage accessible by the server, wherein the details include an address for the service;
means for receiving, at the server, a request to locate a service, wherein the request is received from the home network;
means for locating details about a matching service stored in the storage, wherein the matching service meets criteria specified in the request from the home network; and
means for providing the details about the matching service to the home network, enabling the device to directly contact the matching service using the address specified in the details about the matching service.

22. The apparatus of claim 21, wherein the device is a mobile phone.

23. A non-transitory program storage device readable by a machine tangibly embodying a program of instructions executable by the machine to perform a method for allowing a service on a home network to be accessed by a device outside the home network, the method comprising:
receiving, at a server outside the home network, a registration message from the service;
storing details about the service in a storage accessible by the server, wherein the details include an address for the service;
receiving, at the server, a request to locate a service, wherein the request is received from outside the home network;
locating details about a matching service stored in the storage, wherein the matching service meets criteria specified in the request; and
providing the details about the matching service to the device that requested to locate a service, enabling the device to directly contact the matching service using the address specified in the details about the matching service.

24. The non-transitory program storage device of claim 23, wherein the service operates on a webcam.

25. The non-transitory program storage device of claim 23, wherein the service operates on a home gateway.

26. The non-transitory program storage device of claim 23, wherein the service operates on a television.

27. The non-transitory program storage device of claim 23, wherein the service operates on an energy management system.
